(19) United States
(12) Patent Application Publication
(10) Pub. No.: US 2025/0066612 A1
(43) Pub. Date: Feb. 27, 2025

(54) METHOD FOR PRODUCING IRON OXIDE PIGMENTS

(71) Applicant: LANXESS Deutschland GmbH, Cologne (DE)

(72) Inventors: Norbert Etzenbach, Cologne (DE); Matthias Boers, Krefeld (DE); Stefan Ridder, Krefeld (DE)

(73) Assignee: LANXESS Deutschland GmbH, Cologne (DE)

(21) Appl. No.: 18/721,941

(22) PCT Filed: Dec. 20, 2022
(86) PCT No.: PCT/EP2022/087051

§ 371 Date: Jun. 20, 2024

(30) Foreign Application Priority Data
Dec. 21, 2021 (EP) 21216439.6

(51) Int. Cl. C09C 1/24; C01G 49/02

(52) U.S. Cl. CPC C09C 1/24; C01G 49/02; C01P 2006/63; C01P 2006/64

(57) ABSTRACT

The present invention relates to a method for producing iron oxide pigments according to the Penniman process, characterized in that no separate nucleation step is carried out, and to the use of such iron oxide pigments.

### Method for Producing Iron Oxide Pigments

The present invention relates to a method for producing iron oxide pigments according to the Penniman process, characterized in that no separate nucleation step takes place, and to the use of such iron oxide pigments.

Iron oxide color pigments, which are employed as environmentally benign colorants in ceramics, building materials, plastics, paints and paper, can fundamentally be obtained in black, yellow, red, orange and brown hues.

Iron oxide pigments are obtained, as described in Ullmann's Encyclopedia of Industrial Chemistry, VCH, Weinheim 1992, vol. A20, p. 298ff, by solid phase reactions (red, brown, and black pigments), precipitation and hydrolysis reactions of iron salts (yellow, red, orange and black pigments) and also by oxidation of iron with aromatic nitro compounds in the presence of hydrolyzable, polyhydric salts, the so-called Laux process, as disclosed, for example, in DE 4 63 773 Al and DE 5 15 758 A1.

The solid phase reactions are mainly used for the production of red iron oxides from black precursor products (by calcination) or from FeSO₄ (Copperas process).

a) Laux process

The Laux process starts from nitrobenzene and Fe metal and leads first to black iron oxide or yellow iron oxide and aniline. To produce red iron oxide by this process, the black iron oxide obtained is calcined. The process is technically complex and not easy to manage, as variable proportions of control chemicals must be used to set the desired particle size. In addition, the required apparatus technology is demanding and correspondingly expensive. The reaction also produces aniline as a second product, which, due to its properties, necessitates special occupational hygiene measures.

b) Precipitation process

Yellow, orange, red and black iron oxide pigments can be produced via the precipitation process (U.S. Pat. No. 2,388,659 A1 for yellow iron oxide pigments and U.S. Pat. No. 5,421,878 A1 for red iron oxide by a direct precipitation process).

Iron oxide pigments obtained via the precipitation process are produced from iron salt solutions and alkaline compounds in the presence of air and are associated with the disadvantage that stoichiometric amounts of neutral salts are produced, which have to be discharged with the wastewater or processed in a time-and cost-intensive manner. The direct precipitation process is technically difficult, since α-Fe₂O₃ is accessible only in a narrow range and the reaction is not easy to manage. The red iron oxide produced by the precipitation process has the disadvantage of high salt loads, which pollute the wastewater and are therefore environmentally objectionable.

c) Hydrothermal process

The hydrothermal process is described, for example, in DE 19917786 A1. According to the hydrothermal process, good red iron oxide pigments can be produced for higher-value applications. especially for paints and inks. However, the high process costs dictated by the pressure technology have an adverse effect here. This process is therefore not suitable for simpler applications where inexpensive products are required.

d) Penniman process

According to the Penniman process (disclosed for example in U.S. Pat. Nos. 1,327,061 and 1,368,748), red iron oxide pigments are prepared by dissolving and oxidizing iron metal with addition of a red iron oxide nucleus. Nitric acid is usually used for the nucleation, and so nitrate or ammonia are present in the wastewater, and must be removed with high technical effort. This leads to an increase in production costs, as in the case of the hydrothermal and precipitation processes.

WO 2016/038152 A1 also discloses a Penniman process, which requires a separate nucleation step. Here, the nucleus is produced separately in the form of a suspension of hematite nuclei with a particle size of 100 nm or less and a specific BET surface area of 40 m²/g to 150 m²/g, by reaction of metallic iron, oxygen and nitric acid, and then built up together with iron, iron (II) nitrate solution and oxygen to form the pigment.

However, the Penniman process reduces the amount of neutral salts formed during the precipitation procedure, by using metallic iron as a raw material, which during the process is dissolved by acid that is liberated. With the Penniman process, therefore, a cost-effective process is available for the direct production of iron oxide pigments.

A further advantage of the Penniman process is the production of pigments having advantageous hues while forming a small amount of neutral salts.

However, a disadvantage of the Penniman process is the need for two process steps:

1) nucleation and 2) pigment build-up. This production is therefore operationally effortful. During nucleation, toxic nitrous gases are formed, which require processing. Residues to be landfilled and wastewater containing heavy metals are also formed. The Penniman process is also time-consuming to match the desired hue. Establishing a specific hue also requires constant, effortful monitoring of the production process by trained employees.

### BRIEF DESCRIPTION OF THE FIGURE

FIG. 1 shows CIELAB colorimetric values of examples 1-9.

### DETAILED DESCRIPTION OF THE INVENTION

An object of the present invention was therefore to produce iron oxide pigments by means of a substantially simplified Penniman process. Furthermore, an object of the invention was to minimize or prevent the disadvantages associated with the nucleation step, such as toxic nitrous gases and residues to be landfilled and heavy metal-containing wastewater.

This object has surprisingly been achieved by producing iron oxide pigment according to the

Penniman process without a separate nucleation step.

In the context of the invention, the feature “separate nucleation step” is preferably defined such that the nucleation step is carried out in such a way that the nucleus-typically in the form of a suspension-is present as a product, for example in a separate reactor or container, and then is inserted only as a reactant into the method of the invention for pigment production.

The iron oxide pigment is preferably produced such that
a) a solution containing iron, iron (II) nitrate and water is introduced;
b) the solution is heated;
c) oxygen-containing gases are supplied to the solution during and/or after heating in order to give a pigment suspension; and
d) the pigment suspension is then filtered, washed and/or dried.

The proportion of iron based on the total volume of the solution is preferably from 1 to 250g/l, more preferably from 40 to 85 g/l, very preferably from 50 to 75 g/l.

The proportion of iron (II) nitrate based on the total volume of the solution is preferably from I to 250 g/l, more preferably from 40 to 50 g/l, very preferably from 44 to 46 g/1. With particular preference, the proportion of iron (II) nitrate based on the total volume of the solution is 45 g/l.

The solution is preferably heated under atmospheric pressure to from 60 to 100° C., preferably to from 70 to 95° C., very preferably to from 84 to 86° C. With particular preference, the solution is heated under atmospheric pressure to 85° C.

When working under pressure, the solution is heated preferably to from 50 to 250° C., more preferably to from 100 to 200° C.

Preferably from 1 to 200 l/h oxygen-containing gases/l solution, more preferably from 10 to 40 l/h oxygen-containing gases/l solution, very preferably from 25 to 35 l/h oxygen-containing gases/l solution, with particular preference 30 l/h oxygen-containing gases/l solution are supplied.

Air is preferably used as an oxygen-containing gas.

The supply of oxygen-containing gas takes place preferably over a period of 5 to 150 hours, more preferably over a period of 50 to 120 hours, very preferably over a period of 65 to 75 hours.

This means that not only can the desired color locus be better established compared to the conventional Penniman process by skillful selection of the initial and reaction conditions, but also a large part of the complex monitoring steps of the production process can be reduced.

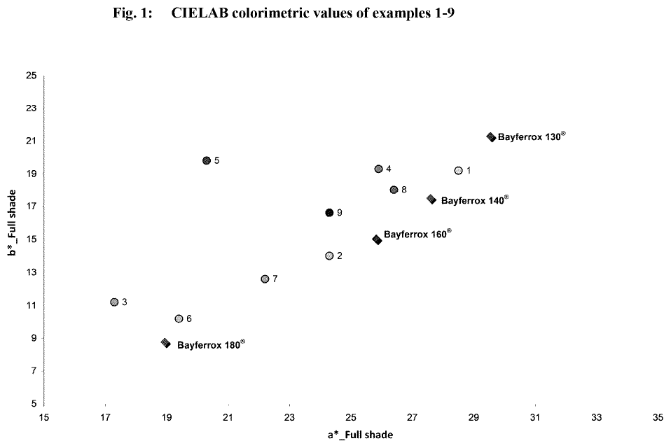

In addition, color spaces can be opened up that would previously have been impossible to achieve with the existing Penniman process. Some of these colorimetric values are represented in FIG. 1.

The iron oxide pigment resulting from the method is preferably deagglomerated and/or ground and/or treated thermally. Preferably, an additive promoting the processability is added to the pigment.

The invention also embraces the use of the iron oxide pigment according to the invention for coloring lime- and/or cement-bound building materials, asphalt, paints, inks, color gels, paper, plastics, food dyes and/or pharmaceutical products. The iron oxide pigment is preferably mixed with the lime-and/or cement-bound building materials, asphalt, paints, inks, color gels, paper, plastics, food dyes and/or pharmaceutical products.

The iron oxide pigment is preferably used as a technical oxide in the field of catalysts, abrasives, etc.

The subject-matter of the present invention arises not only from the subject-matter of the individual claims, but also from the combination of the individual claims among themselves. The same applies to all parameters disclosed in the description and their combinations as desired.

The following examples explain the invention in more detail, without thereby intending to cause any restriction of the invention.

1. Description of the measurement methods used 1.1 Apparatus

Heatable 9-liter steel boiler, sieve bottom insert, gassing ring, blade stirrer, combination pH electrode, thermocouple.

1.2 Working instructions

The solution containing iron, iron (II) nitrate and water was introduced into the steel boiler. This solution was then heated. The heated solution was gassed with air for a certain time. This gassing of the solution was carried out until the pigment suspension reached the desired color space. The resulting pigment suspension was then filtered and the resultant pigment filter cake was washed with water, dried and ground.

1.3 Colorimetry (full shade)

The coloristic evaluation of the pigments took place in Alkydal L 64® thixotropic (non-curing alkyd resin from Bayer AG) at a pigment volume concentration of 10%. The remission values and CIELAB data (DIN 5033, Part 7) were determined using a measuring device with Ulbricht sphere (illumination conditions d/8″, standard illuminant CI2″) including surface reflection. The remission values obtained were converted into the CIELAB color data system in accordance with DIN 5033, Part 3.

A spectrophotometer (“colorimeter”) with the measurement geometry d/8 without a gloss trap was used. This measurement geometry is described in ISO 7724/2-1984 (E), section 4.1.1, in DIN 5033 Part 7 (July 1983), section 3.2.4 and in DIN 53236 (January 1983), section 7.1.1.

A DATAFLASH® 2000 measuring device (Datacolor International Corp., USA) was used. The colorimeter was calibrated against a white ceramic working standard as described in ISO 7724/2-1984 (E) section 8.3. The reflection data of the working standard against an ideal matt white body are stored in the colorimeter, so that after calibration with the white working standard, all color measurements are referred to the ideal matt white body. The black point calibration was carried out with a black hollow body from the colorimeter manufacturer.

The result of the color measurement is a reflection spectrum. For the calculation of colorimetric quantities, it does not matter under which illuminant the measurement was made (except for fluorescent samples). Any desired colorimetric quantity can be calculated from the reflection spectrum. The colorimetric quantities used in this case are calculated in accordance with DIN 6174 (CIELAB values). Among other values, the colorimetric value “b*” is calculated in accordance with DIN 6174. The following applies to the color impression: the more negative b* is, the more bluish the color pigment is.

Any gloss trap present was excluded. The temperature of colorimeter and test specimen was around 25° C.±5° C.

1.4 Residual iron

The residual iron was determined after the reaction, with the unused iron being reweighed in the air convection drying oven after rinsing by means of water and drying at 80° C.

1.5 Final Fe analysis

Fe determination was performed by cerimetry under inert conditions. After digestion of 2 to 10 cm³ (depending on the solids concentration) of the sample in 20 cm3 water and 20 cm³ hydrochloric acid (37%), the iron (II), (III) chloride solution thus obtained was admixed with 10 cm³ sulfuric acid (around 48.5 wt. %), made up to 200 cm³ with deionized water and potentiometrically titrated on an automatic titrator (Mettler Memotitrator DL70). A titer-stable cerium (IV) sulfate solution (c[Ce(SO4)2]=0.25 mol/l) was used for the titration, with the actual titration taking place in several steps, which were controlled by the automatic titrator.

In the first step, the iron (Il) was oxidized to iron (III) with cerium (IV) sulfate solution. In the second step, the reduction of iron (III) to iron (II) is carried out with a small excess of 7% titanium (III) chloride solution (around 7% in 10% HC1). In the third step, the total iron was titrated with cerium (IV) sulfate solution in a 2-step titration, where the excess titanium (III) resulting from the reduction was first oxidized to titanium (IV) and then the iron (II) to iron (III). The titration results were then determined from the raw data and output by the automatic titrator.

I. Example 1: Run time 116 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 5110 | 45 | 366 | 85 | 30 | 38.0 | 28.5 | 19.2 |

Example 2: Run time 106 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 45 | 366 | 85 | 30 | 36.3 | 24.3 | 14.0 |

III. Example 3: Run time 72 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 25 | 366 | 85 | 30 | 36.5 | 17.3 | 11.2 |

IV. Example 4: Run time 72 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 85 | 366 | 85 | 30 | 38.7 | 25.9 | 19.3 |

V. Example 5: Run time 59 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 45 | 366 | 75 | 30 | 42.4 | 20.3 | 19.8 |

VI. Example 6: Run time 59 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 45 | 366 | 95 | 30 | 33.0 | 19.4 | 10.2 |

VII. Example 7: Run time 72 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 45 | 366 | 85 | 10 | 35.2 | 22.2 | 12.6 |

VIII. Example 8: Run time 72 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 45 | 366 | 85 | 60 | 37.4 | 26.4 | 18.0 |

IX. Example 9: Run time 72 h

| Batch | | | Temper- | Air | CIELAB colorimetric | | |
|---|---|---|---|---|---|---|---|
| volume | Fe(NO₃)₂ | Iron | ature | [l/h/l | values, full shade | | |
| [cm³] | [g/l] | [g] | [° C.] | batch] | L* | a* | b* |
| 7000 | 45 | 366 | 85 | 30 | 36.1 | 24.3 | 14.6 |

TABLE I
Summary of examples 1-9 with CIELAB colorimetric values:

| | | | | | | Finished batch | | | |
|---|---|---|---|---|---|---|---|---|---|
| Test conditions | | | | | | | CIELAB colorimetric values, | | |
| Batch | Initial charge | | Temper- | | Gassing | Run | full shade after 60 | | |
| size | Fe(II) nitrate | Fe | ature | Stirring | Air | time | sec grinding MDA* | | |
| [cm³] | [g/l] | [g] | [° C.] | [rpm] | [l/h/l batch] | [h] | L* | a* | b* |
| 5110 | 45 | 366 | 85 | 200 | 30 | 116 | 38.0 | 28.5 | 19.2 |
| 7000 | 45 | 366 | 85 | 200 | 30 | 106 | 36.6 | 24.3 | 14.0 |
| 7000 | 25 | 366 | 85 | 200 | 30 | 72 | 36.5 | 17.3 | 11.2 |
| 7000 | 85 | 366 | 85 | 200 | 30 | 72 | 38.7 | 25.9 | 19.3 |
| 7000 | 45 | 366 | 75 | 200 | 30 | 59 | 42.4 | 20.3 | 19.8 |
| 7000 | 45 | 366 | 95 | 200 | 30 | 59 | 33.0 | 19.4 | 10.2 |
| 7000 | 45 | 366 | 85 | 200 | 10 | 72 | 35.2 | 22.2 | 12.6 |
| 7000 | 45 | 366 | 85 | 200 | 60 | 72 | 37.4 | 26.4 | 18.0 |
| 7000 | 45 | 366 | 85 | 200 | 30 | 72 | 36.1 | 24.3 | 16.6 |

*MDA = Grinding by microdismembrator with agate lining.

TABLE II
Summary of the test conditions of the examples

| | Test conditions | | | | | | | |
|---|---|---|---|---|---|---|---|---|
| | Batch | Initial charge | | Temper- | | Gassing | Run | |
| | size | Fe(II) nitrate | Fe | ature | Stirring | Air | time | STY |
| Example | [cm³] | [g/l] | [g] | [° C.] | [rpm] | [l/h/l batch] | [h] | [g/l/h] |
| 1 | 5110 | 45 | 366 | 85 | 200 | 30 | 116 | 0.6 |
| 2 | 7000 | 45 | 366 | 85 | 200 | 30 | 106 | 0.9 |
| 3 | 7000 | 25 | 366 | 85 | 200 | 30 | 72 | 0.5 |
| 4 | 7000 | 85 | 366 | 85 | 200 | 30 | 72 | 1.7 |
| 5 | 7000 | 45 | 366 | 75 | 200 | 30 | 59 | 0.2 |
| 6 | 7000 | 45 | 366 | 95 | 200 | 30 | 59 | 0.4 |
| 7 | 7000 | 45 | 366 | 85 | 200 | 10 | 72 | 0.8 |
| 8 | 7000 | 45 | 366 | 85 | 200 | 60 | 72 | 0.8 |
| 9 | 7000 | 45 | 366 | 85 | 200 | 30 | 72 | 1.0 |

STY = Space-time yield or the amount of substance/hematite produced in g/l/h.

TABLE III
Summary of the product characteristics of the examples

| | Finished batch | | | | | | |
|---|---|---|---|---|---|---|---|
| | Yield | Residual | Final Fe analysis | | CIELAB colorimetric values, full | | |
| | volume | iron | Fe(NO₃)₂ | Fe₂O₃ | shade after 60 sec. grinding MDA | | |
| Example | [l] | [g] | [g/l] | [g/l] | L* | a* | b* |
| 1 | 3200 | 200.0 | 12.0 | 68.6 | 38.0 | 28.5 | 19.2 |
| 2 | 4800 | 91.0 | 5.3 | 91.4 | 36.6 | 24.3 | 14.0 |
| 3 | 6000 | 262.7 | 10.7 | 34.4 | 36.5 | 17.3 | 11.2 |
| 4 | 6100 | 65.1 | 40.2 | 120.7 | 38.7 | 25.9 | 19.3 |
| 5 | 6250 | 290.2 | 34.0 | 12.8 | 42.4 | 20.3 | 19.8 |
| 6 | 6100 | 252.4 | 30.8 | 21.3 | 33.0 | 19.4 | 10.2 |
| 7 | 6400 | 202.0 | 1.3 | 54.3 | 35.2 | 22.2 | 12.6 |
| 8 | 4000 | 253.0 | 33.4 | 55.1 | 37.4 | 26.4 | 18.0 |
| 9 | 4800 | 199.8 | 13.7 | 71.2 | 36.1 | 24.3 | 16.6 |

1. A production of iron oxide pigment according to the Penniman process, wherein no separate nucleation step takes place.

2. The production as claimed in claim 1, characterized in that
a) a solution containing iron, iron (Il) nitrate and water is introduced;
b) the solution is heated;
c) oxygen-containing gases are supplied to the solution during and/or after heating in order to give a pigment suspension; and
d) the pigment suspension is then filtered, washed and/or dried.

3. The production as claimed in claim 1, wherein the proportion of iron, based on the total volume of the solution, is from 1 to 250g/l, in particular from 40 to 85 g/l.

4. The production as claimed in claim 3, wherein the proportion of iron, based on the total volume of the solution, is from 50 to 75 g/l.

5. The production as claimed in claim 1, wherein the proportion of iron(II) nitrate, based on the total volume of the solution, is from 1 to 250 g/l, in particular from 40 to 50 g/l.

6. The production as claimed in claim 5, wherein the proportion of iron(II) nitrate, based on the total volume of the solution, is from 44 to 46 g/l, in particular 45 g/l.

7. The production as claimed in claim 1, wherein the solution is heated under atmospheric pressure to from 60 to 100° C., in particular to from 70 to 95° C.

8. The production as claimed in claim 7, wherein the solution is heated to from 84 to 86° C.

9. The production as claimed in claim 1, wherein the solution is heated under pressure to from 50 to 250° C., in particular to from 100 to 200°° C.

10. The production as claimed in claim 1, wherein from 1 to 200 l/h oxygen-containing gases/l solution, in particular from 10 to 40 l/h oxygen-containing gases/l solution, is supplied.

11. The production as claimed in claim 10, wherein from 25 to 35 l/h oxygen-containing gases/l solution is supplied.

12. The production as claimed in claim 1, wherein air is used as an oxygen-containing gas.

13. The production as claimed in claim 1, wherein the supply of oxygen-containing gases takes place over a period of 5 to 150 hours, in particular over a period of 50 to 120 hours.

14. The production as claimed in claim 13, wherein the supply of oxygen-containing gases takes place over a period of 65 to 75 hours.

15. The production as claimed in claim 1, wherein the iron oxide pigment is deagglomerated or ground.

16. The production as claimed in claim 1, wherein an additive promoting the processability is added to the pigment.

17. The production as claimed in claim 1, wherein the iron oxide pigment is treated thermally.

18. A method for coloring lime-and/or cement-bound building materials, asphalt, paints, inks, color gels, paper, plastics, food dyes and/or pharmaceutical products with the iron oxide pigment produced as claimed in claim 1, wherein the iron oxide pigment is mixed with the lime- and/or cement-bound building materials, asphalt, paints, inks, color gels, paper, plastics, food dyes and/or pharmaceutical products.

19. The use of the iron oxide pigments produced as claimed in claim 1, wherein the iron oxide pigment is used as a technical oxide in the field of catalysts, abrasives, etc.
